(19) United States
(12) Patent Application Publication
(10) Pub. No.: US 2006/0008191 A1
(43) Pub. Date: Jan. 12, 2006

(54) Dynamic bearing device

(76) Inventors: Takehito Tamaoka, Kyoto-shi (JP); Tetsuya Kurimura, Kuwana-shi (JP); Huyuki Ito, Kuwana-shi (JP)

Correspondence Address: J C PATENTS, INC., 4 VENTURE, SUITE 250, IRVINE, CA, 92618, US

(21) Appl. No.: 11/169,504

(22) Filed: Jun. 28, 2005

(30) Foreign Application Priority Data
Jul. 1, 2004 (JP) 2004-195752

(51) Int. Cl. F16C 32/06

(52) U.S. Cl. 384/123

(57) ABSTRACT

A dynamic bearing device includes: a housing; a bearing sleeve arranged inside the housing; a shaft member rotating relative to the housing and the bearing sleeve; and a radial bearing portion supporting the shaft member radially in a non-contact manner by a dynamic pressure action of a lubricant generated in a radial bearing clearance. The housing is formed of a leadless brass whose Sn content is regulated to 0.01 wt % or less.

### BACKGROUND OF THE INVENTION

The present invention relates to a dynamic bearing device rotatably supporting a shaft member by a dynamic pressure action in a non-contact manner through the intermediation of a lubricant film generated in a radial bearing clearance. This bearing device is suitable for use in a spindle motor of an information apparatus, for example, a magnetic disc apparatus, such as an HDD or an FDD, an optical disc apparatus, such as a CD-ROM, a CD-R/RW, or a DVD-ROM/RAM, and a magneto-optical disc apparatus, such as an MD or an MO.

For example, in a dynamic bearing device incorporated in the spindle motor of a disc device, such as an HDD, there are provided a radial bearing portion rotatably supporting a shaft member in a radial direction in a non-contact manner and a thrust bearing portion rotatably supporting the shaft member in a thrust direction. As the radial bearing portion, there is used a dynamic bearing having grooves for dynamic pressure generation (dynamic pressure generating grooves) in the inner peripheral surface of the bearing sleeve or the outer peripheral surface of the shaft member. As the thrust bearing portion, there is used, for example, a dynamic bearing in which dynamic pressure generating grooves are provided in the end surfaces of the flange portion of the shaft member or the surfaces opposed thereto (the end surfaces of the bearing sleeve, the end surfaces of a thrust member fixed to the housing, the inner bottom surface of the base of the housing, etc.) (see, for example, JP 2002-61637 A and JP 2002-61641 A). In some cases, there is used, as a thrust bearing portion, a bearing supporting one end surface of a shaft member by means of a thrust plate in a contact fashion (a so-called pivot bearing) (see, for example, JP 11-191943 A).

Usually, the bearing sleeve is fixed at a predetermined position of the inner periphery of a housing; further, to prevent lubricant poured into the inner space of the housing from leaking to the exterior, a seal member is often arranged at the opening of the housing (see, for example, JP 2002-61637 A). Further, there are cases where the opening of the housing and the seal member are integrally formed (see, for example, JP 2002-61641 A).

In a dynamic bearing device of this type, free-cutting brass is often used as the material of the components (the housing, bearing sleeve, thrust member, etc.) of the bearing device. This is due to the fact that free-cutting brass is relatively hard and superior in workability. Generally speaking, however, several % of lead, such as C3604, is added to free-cutting brass for better machinability. Since the adverse effects of this lead on the human body and the environment have been pointed out, it has become mainstream to use a leadless brass containing no lead or a brass whose lead content is regulated to a minute amount instead (see, for example, JP 7-310133 A). Regarding such a dynamic bearing also, it has already been proposed to form the components such as the housing of a leadless brass (see JP 2003-172336 A).

Further, apart from a soft metal, such as brass, a sintered metal is used as the material of the bearing sleeve. For example, JP 2003-172336 A discloses a bearing sleeve formed of a sintered metal whose main component is copper and having in the inner peripheral surface thereof dynamic pressure generating grooves. Further, for example, JP8-32936B, JP9-41069A, and JP9-95759A disclose sintered oilless bearings formed of a copper type or copper-iron type sintered metal material.

Generally speaking, a leadless brass often contains a required amount of Sn for higher dezincification corrosion resistance. For example, in JP 7-310133 A, 0.2 to 3 wt % of Sn is contained. Further, generally, in a copper type or copper-iron type sintered metal, a requisite amount of Sn may be contained in order to promote binding of the metal powder grains for higher strength. For example, in JP 8-32936 B, 2 to 5.5 wt % of Sn is contained; in JP 9-41069 A, 0.1 to 5 wt % of Sn is contained; and in JP 9-95759 A, 0.5 to 3.0 wt % of Sn is contained.

However, in a disk device, such as an HDD, the various elements contained in the components are also strictly controlled, and, recently, an attacking property of the Sn contained in the components with respect to the recording disk, head, etc. has been pointed out.

### SUMMARY OF THE INVENTION

An object of the present invention is to provide a dynamic bearing device which, if incorporated into a disk device, such as an HDD, exhibits little attacking property with respect to the peripheral components, such as the recording disk and head.

To achieve the above object, the present invention includes: a housing; a bearing sleeve arranged inside the housing; a shaft member rotating relative to the housing and the bearing sleeve; and a radial bearing portion supporting the shaft member radially in a non-contact manner by a dynamic pressure action of a lubricant generated in a radial bearing clearance, in which the housing is formed of a leadless brass whose Sn content is regulated to 0.01 wt % or less.

In this specification, the term “leadless brass” refers to a brass whose Pb content is regulated to a minute amount or a brass containing no Pb. Preferably, the Pb content is regulated to 0.1 wt % or less, more preferably, to 0.01 wt % or less, and most preferably, to 0.001 wt % or less. In such a leadless brass, the Sn content is regulated to 0.01 wt % or less. Here, for better machinability, the leadless brass may contain a requisite amount of Bi and Se.

Examples of a leadless brass satisfying the above conditions include “HM-30” (containing less than 0.1 wt % of Pb and no Sn) manufactured by Nippon Shindo Co., Ltd., “ECO BRASS” (containing 0.1 wt % or less of Pb and no Sn) manufactured by Sanpo Shindo Kogyo Co., Ltd., and “Bz50” (containing 0.001 wt % of Pb and 0.003 wt % of Sn) manufactured by SAN-ETSU METAL Co., Ltd. The housings of dynamic bearing devices formed of these leadless brasses exhibit satisfactory workability (machinability, forgeability, and castablity) and contain Pb, which is an environmental load element, in an amount regulated to not more than a minute amount, so that they are friendly to man and the environment and exhibit high recycling property. Further, the Sn content of such housings is regulated to a minute amount or less, so that if incorporated in a disk device, such as an HDD, such housings scarcely attack the peripheral components, such as the recording disk and head, thus contributing to an increase in the service life of and an improvement in the reliability of the disk device.

In a dynamic bearing device further equipped with a thrust bearing portion supporting the shaft member in the thrust direction in a non-contact manner by the dynamic pressure action of the lubricant generated in the thrust bearing clearance, at least one of the housing and the thrust member constituting the thrust bearing portion is formed of a leadless brass as mentioned above.

Further, to achieve the above object, in accordance with the present invention, there is provided a dynamic bearing device comprising a housing, a bearing sleeve arranged inside the housing, a shaft member rotating relative to the housing and the bearing sleeve, and radial bearing portion supporting the shaft member radially by a dynamic pressure action of lubricant generated in a radial bearing clearance, wherein the bearing sleeve is formed of a copper type or copper-iron type sintered metal whose Sn content is regulated to 0.01 wt % or less (as a material with no Sn powder added there to included). The bearing sleeve contains Sn in an amount regulated to not more than a minute amount, so that, if incorporated in a disk device, such as an HDD, it exhibits little attacking property with respect to the peripheral components, such as the recording disk and head, thereby contributing to an increase in the service life of and an improvement in the reliability of the disk device.

According to the present invention, it is possible to provide a dynamic bearing device which, if incorporated into a disk device, such as an HDD, exhibits little attacking property with respect to the peripheral components, such as the recording disk and head, thus contributing to an increase in the service life of and an improvement in the reliability of the disk device.

### BRIEF DESCRIPTION OF THE DRAWINGS

FIG. 1 is a sectional view of a spindle motor for an information apparatus using a dynamic bearing device according to the present invention.

FIG. 2 is a sectional view of a dynamic bearing device according to an embodiment of the present invention.

### DESCRIPTION OF THE PREFERRED EMBODIMENTS

Embodiments of the present invention will be hereinafter described.

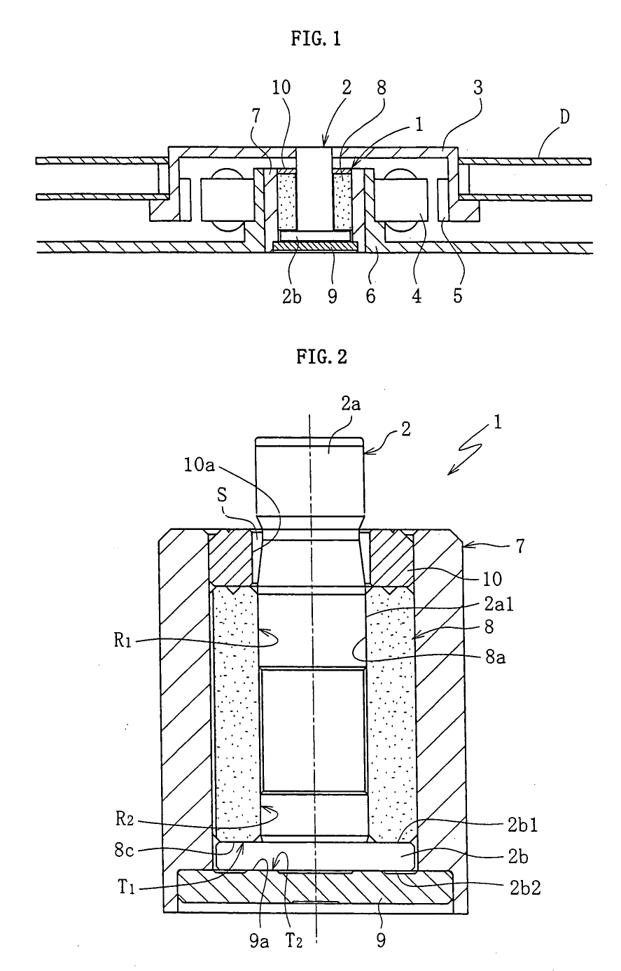

FIG. 1 shows a conceptual example of a construction of a spindle motor for an information apparatus into which a fluid bearing device 1 according to this embodiment is incorporated. The spindle motor is used for a disk drive device such as an HDD, and includes the dynamic bearing device 1 for rotatably supporting a shaft member 2 in a non-contact manner, a rotor (disk hub) 3 attached to the shaft member 2, a stator 4, and a rotor magnet 5 radially opposite to each other with a gap therebetween, for example. The stator 4 is mounted on the outer periphery of a bracket 6, while the rotor magnet 5 is mounted to the inner periphery of the disk hub 3. A housing 7 of the dynamic bearing device 1 is fixed to the inner periphery of the bracket 6. The disk hub 3 is holding one or a plurality of disks D such as magnetic disks. Energizing the stator 4 rotates the rotor magnet 5 by the electromagnetic force therebetween, thereby rotating the disk hub 3 and the shaft member 2 integrally.

FIG. 2 shows the dynamic bearing device 1. The dynamic bearing device 1 is generally configured with the structural parts including the housing 7, a bearing sleeve 8, a thrust member 9 and a seal member 10 fixed to the housing 7, and the shaft member 2.

Between an inner peripheral surface 8a of the bearing sleeve 8 and an outer peripheral surface 2a1 of a shaft portion 2a of the shaft member 2, there are provided a first radial bearing portion R1 and a second radial bearing portion R2 so as to be axially spaced apart from each other. Further, between a lower end surface 8c of the bearing sleeve 8 and an upper end surface 2b1 of a flange portion 2b of the shaft member 2, there is provided a first thrust bearing portion T1, and, between an end surface 9a of a thrust member 9 and a lower end surface 2b2 of the flange portion 2b, there is provided a second thrust bearing portion T2. For the sake of convenience, the side of the thrust member 9 will be referred to as the lower side, and the side opposite to the thrust member 9 will be referred to as the upper side.

The housing 7 is formed in a cylindrical configuration of a leadless brass whose Sn content is regulated to 0.01 wt % or less, for example, “Bz50” (containing 0.001 wt % of Pb and 0.003 wt % of Sn) manufactured by SAN-ETSU METAL Co., Ltd. Conventionally, the Sn content of a housing of this type is approximately 0.2 to 1 wt %.

The shaft member 2 is formed, for example, of a metal material, such as stainless steel, and is equipped with the shaft portion 2a and the flange portion 2b provided integrally or separately at the lower end of the shaft portion 2a.

The bearing sleeve 8 is formed in a cylindrical configuration using, for example, a porous material consisting of a copper sintered metal (whose main component is copper) controlled by less than 0.01 wt % of Sn, and is secured at a predetermined position of the inner peripheral surface of the housing 7.

In the inner peripheral surface 8a of this bearing sleeve 8, formed of a sintered metal, there are formed upper and lower areas axially spaced apart from each other and constituting the radial bearing surfaces of the first radial bearing portion R1 and the second radial bearing portion R2, and, in these two areas, for example, there are herringbone-shaped dynamic pressure generating grooves respectively formed.

In the lower end surface 8c of the bearing sleeve 8 constituting the thrust bearing surface of the first thrust bearing portion T1, there are formed dynamic pressure generating grooves of, for example, a spiral or herringbone-like configuration.

The thrust member 9 is formed in a disc-like configuration of a leadless brass whose Sn content is regulated to 0.01 wt % or less, for example, “Bz50” manufactured by SAN-ETSU METAL Co., Ltd., and is fixed to the lower end portion of the inner peripheral surface of the housing 7. In the end surface 9a of the thrust member 9 constituting the thrust bearing surface of the second thrust bearing portion T2, there are formed dynamic pressure generating grooves of, for example, the herringbone-like or spiral configuration.

The seal member 10 is formed in a ring-like configuration of a leadless brass whose Sn content is regulated to 0.01 wt % or less, for example, “Bz50” manufactured by SAN-ETSU METAL Co., Ltd., and is fixed to the upper end portion of the inner peripheral surface of the housing 7. The inner peripheral surface 10a of the seal member 10 forms a seal space S between the outer peripheral surface 2a1 of the shaft portion 2a.

The inner space of the housing 7, sealed up by the seal member 10 and the thrust member 9, is filled with a lubricant inclusive of the inner pores of the bearing sleeve 8. The oil surface level of the lubricant is maintained within the range of the seal space S.

During rotation of the shaft member 2, the areas of the inner peripheral surface 8a of the bearing sleeve 8 constituting the radial bearing surfaces (the upper and lower areas) are opposed to the outer peripheral surface 2a1 of the shaft portion 2a through the intermediation of a radial bearing clearance. Further, the area of the lower end surface Bc of the bearing sleeve 8 constituting the thrust bearing surface is opposed to the upper end surface 2b1 of the flange portion 2b through the intermediation of a thrust bearing clearance, and the end surface 9a of the thrust member 9 constituting the thrust bearing surface is opposed to the lower end surface 2b2 of the flange portion 2b through the intermediation of a thrust bearing clearance. Then, as the shaft member 2 rotates, a dynamic pressure of the lubricant is generated in the radial bearing clearance, and the shaft portion 2a of the shaft member 2 is rotatably supported in the radial direction in the non-contact manner with an oil film of the lubricant formed in the radial bearing clearance. As a result, there are formed the first radial bearing portion R1 and the second radial bearing portion R2 rotatably supporting the shaft member 2 in the radial direction in the non-contact manner. At the same time, a dynamic pressure of the lubricant is generated in the thrust bearing clearance, and the flange portion 2b of the shaft member 2 is rotatably supported in both thrust directions in the non-contact manner with an oil film of the lubricant formed in the thrust bearing clearance. As a result, there are formed the first thrust bearing portion T1 and the second thrust bearing portion T2 rotatably supporting the shaft member 2 in the thrust directions in the non-contact manner.

In the above construction, one of the thrust member 9 and the seal member 10 may be formed integrally with the housing 7.

What is claimed is:

1. A dynamic bearing device comprising:
a housing;
a bearing sleeve arranged inside the housing;
a shaft member rotating relative to the housing and the bearing sleeve; and
a radial bearing portion supporting the shaft member radially in a non-contact manner by a dynamic pressure action of a lubricant generated in a radial bearing clearance,
wherein the housing is formed of a leadless brass whose Sn content is regulated to 0.01 wt % or less.

2. A dynamic bearing device comprising:
a housing;
a bearing sleeve arranged inside the housing;
a shaft member rotating relative to the housing and the bearing sleeve;
a radial bearing portion supporting the shaft member radially in a non-contact manner by a dynamic pressure action of a lubricant generated in a radial bearing clearance; and
a thrust bearing portion supporting the shaft member in a non-contact manner in a thrust direction by a dynamic pressure action of a lubricant generated in a thrust bearing clearance,
wherein at least one of the housing and a thrust member constructing the thrust bearing portion is formed of a leadless brass whose Sn content is regulated to 0.01 wt % or less.

3. A dynamic bearing device comprising:
a housing;
a bearing sleeve arranged inside the housing;
a shaft member rotating relative to the housing and the bearing sleeve;
and a radial bearing portion supporting the shaft member radially in a non-contact manner by a dynamic pressure action of a lubricant generated in a radial bearing clearance,
wherein the bearing sleeve is formed of a copper type or copper-iron type sintered metal whose Sn content is regulated to 0.01 wt % or less.
